(19) United States
(12) Patent Application Publication
(10) Pub. No.: US 2005/0246082 A1
(43) Pub. Date: Nov. 3, 2005

(54) Working machine driving unit

(75) Inventors: Masatoshi Miki, Tokyo (JP); Nobuaki Matoba, Tokyo (JP)

Correspondence Address: DARBY & DARBY P.C., P. O. BOX 5257, NEW YORK, NY, 10150-5257, US

(73) Assignee: Shin Caterpillar Mitsubishi Ltd., Tokyo (JP)

(21) Appl. No.: 10/513,389

(22) PCT Filed: Oct. 16, 2003
(86) PCT No.: PCT/JP03/13248

§ 371 Date: Jan. 11, 2005

(30) Foreign Application Priority Data
Dec. 13, 2002 (JP) 2002-363169

(51) Int. Cl. G06G 7/00

(52) U.S. Cl. 701/50

(57) ABSTRACT

A driving device of a work machine includes a power generator adapted to be driven by an engine, and a power storage device for storing the electric power generated by the power generator. Electric motors and a motor generator, both adapted to be operated by electric power supplied from either one or both of the power generator and the power storage device respectively drive pumps and a pump motor. Supporting circuits for feeding supporting hydraulic oil are provided between a plurality of driving circuits that drive a plurality of hydraulic actuators of a working unit by oil hydraulics generated by the pumps and the pump motor. By enabling the plurality of driving circuits to effectively share excess energy, the invention makes possible a compact construction of a driving device of a work machine.

### TECHNICAL FIELD

The present invention relates to a driving device for a hydraulic excavator or any other work machine equipped with a power source that uses both an engine and a power generating device.

### BACKGROUND OF THE INVENTION

FIGS. 9 and 10 refer to a conventional art. FIG. 9 illustrates the structure of a hydraulic excavator, and FIG. 10 is a circuit diagram showing the structure of its hydraulic system.

Referring to FIG. 9, an upper structure 2 is rotatably mounted on an undercarriage 1. A working unit 6 comprising a boom 3, a stick 4, and a bucket 5 is mounted on the upper structure 2. The boom 3 is attached to the upper structure 2 so that the boom 3 can be swung by means of boom cylinders 3a. The stick 4 is attached to the distal end of the boom 3 so that the stick 4 can be swung by means of a stick cylinder 4a. The bucket 5 is attached to the distal end of the stick 4 and is adapted to be driven by a bucket cylinder 5a.

As shown in FIG. 10, a conventional hydraulic system comprises an engine 7 mounted on the upper structure 2, hydraulic pumps 8,9 of a variable delivery type, a pilot pump 10 for the supply of pilot pressure, a pilot-operated valve unit 11, an operating valve (hereinafter called “remote control valve”) 12, an engine speed setting device 13, a controller 14, the aforementioned boom cylinders 3a, stick cylinder 4a, and bucket cylinder 5a for driving the working unit 6, a hydraulic motor 15 for rotating the upper structure 2, and hydraulic traveling motors 16a,16b for driving the undercarriage 1. The hydraulic pumps 8,9 are provided with swash plate controllers 8a,9a that are adapted to be driven by the engine 7. The valve unit 11 serves to distribute pressurized oil from the hydraulic pumps 8,9 to the actuators. The remote control valve 12 serves to pilot-operate the valve unit 11. The engine speed setting device 13 serves to set the rotation speed of the engine 7. The controller 14 controls respective outputs of the engine 7 and the hydraulic pumps 8,9.

Referring to FIG. 10, the remote control valve 12 is operated to change over the valve unit 11 so that the pressurized oil from the hydraulic pumps 8,9 is distributed to the actuators, thereby operating the work machine.

As described above, a driving device that calls for an engine 7 to directly drive hydraulic pumps 8,9 is normally equipped with a high power engine capable of coping with the maximum load so that the work machine is capable of various types of operation ranging from a light load to a heavy load. However, heavy load operation occupies only a part of the entire work period.

When a conventional construction machine equipped with such a high-power engine performs light load operation or medium load operation, which occupies a major part of the entire work, the pressurized oil discharged from the hydraulic pumps 8,9 is throttled by the valve unit 11 and then distributed to the actuators, such as the boom cylinders 3a, the stick cylinder 4a, and the bucket cylinder 5a. Such a conventional system is disadvantageous in such aspects as fuel consumption, noises and production costs.

The conventional driving device presents a problem also in light load operation, which is typically performed under throttled engine power or low engine speed; the lower the engine speed, the smaller and more unstable the torque due to the characteristics of the engine 7. As a result, the engine 7 becomes prone to stalling or uneven rotation, resulting in unacceptable operatability.

In order to solve these problems, the power source for a hydraulic excavator may comprise a power generating device to be driven by an engine. The electric power supplied from the power generating device is stored in a battery and used to rotate a single motor, which drives hydraulic pumps. The hydraulic oil fed from the hydraulic pumps is controlled by a common valve unit so as to operate hydraulic traveling motors at the right and left sides of the undercarriage, a hydraulic rotating motor of the upper structure and various actuators of the working unit, such as boom cylinders, an arm cylinder and a bucket cylinder. One of examples of such a driving device is described in Japanese Laid-open Patent Publication No. 2001-11888.

In comparison with the conventional art shown in FIG. 10, the hydraulic excavator described in the aforementioned patent publication enables the more efficient driving of the engine. However, as the circuits for driving the respective actuators are provided independently of one another, excess energy is not effectively used by the driving circuits of the respective hydraulic actuators.

In order to solve the above problems, an object of the invention is to provide a work machine driving device which makes possible a compact construction by enabling a plurality of driving circuits to effectively share excess energy.

### SUMMARY OF THE INVENTION

A work machine driving device according to the invention is for operating a working unit by a plurality of hydraulic actuator systems and comprises an engine, a power generating device driven by the engine, a power storage device for storing the electric power generated by the power generating device, a plurality of driving circuits, and one or more supporting circuits. Each driving circuit is provided for each respective hydraulic actuator system and adapted to be operated by electric power supplied from either one of or both the power generating device and the power storage device so as to generate hydraulic pressure, thereby driving each respective hydraulic actuator system. Each supporting circuit serves to feed supporting hydraulic fluid from one driving circuit to another driving circuit to make up shortfall in the hydraulic fluid. As the supporting circuits enable the plurality of driving circuits to effectively share excess energy generated from hydraulic fluid so that the capacity of each driving circuit, which is adapted to generate hydraulic pressure by being operated by electricity supplied from the power generating device or the power storage device, both of which are driven by the engine, can be consequently reduced. Therefore, the inclusion of the supporting circuits enables the various components of the driving circuits to be made compact at reduced production costs.

Each driving circuit of a work machine driving device according to another feature of the invention includes a motor, a pump to be driven by the motor, a valve unit, and a tank. The motor is adapted to be operated at a controllable rotation speed by electric power supplied from either one of or both the power generating device and the power storage device. The valve unit is adapted to control the direction of the hydraulic fluid discharged from the pump so as to feed the hydraulic fluid to the corresponding hydraulic actuator system. The tank is provided so that the hydraulic fluid that has been supplied from the pump to the hydraulic actuator system is recovered therein and returned to the pump. As the motor, of which rotation speed can be controlled, controls the pump flow rate, the necessity for each valve unit to throttle the circuit in order to control the flow rate is eliminated. Therefore, the pressure loss caused by the valve unit can be reduced. By thus eliminating the throttle loss that would be caused by flow control by valve units and piping of a conventional system, the invention limits unnecessary heat generation or otherwise improves the energy efficiency.

Each driving circuit of a work machine driving device according to yet another feature of the invention is integrated with each respective hydraulic actuator system. Integration of each driving circuit with each respective hydraulic actuator system reduces the loss resulting from the piping of each driving circuit and also eliminates the necessity of the space for installation of the driving circuits on the machine body.

At least one of the driving circuits of a work machine driving device according to yet another feature of the invention includes a closed circuit, a bi-directional pump motor in the closed circuit, and a motor generator. The pump motor has functions of both a pump for supplying hydraulic fluid and a hydraulic motor adapted to operate by receiving hydraulic fluid. The motor generator has functions of both an electric motor, which is adapted to be operated by electric power supplied from either one of or both the power generating device and the power storage device so as to drive the pump motor, and a power generating device, which is adapted to be driven by the pump motor so as to generate electric power. By driving the pump motor in the closed circuit as a pump by means of the motor generator, which has a function as a motor, the corresponding hydraulic actuator system can be operated. At that time, the direction of action of the hydraulic actuator system can be controlled by selecting the discharge direction from the bi-directional pump motor by means of rotation direction of the motor generator. When the hydraulic actuator system is operated by an external load, the hydraulic actuator system functions as a pump so that hydraulic pressure is generated in the closed circuit and operates the pump motor as a hydraulic motor. As the pump motor drives the motor generator so that the motor generator functions as a device to generate electric power, which is charged on the power storage device, thereby reducing the burden imposed on the engine and enabling the effective use of excess energy.

A work machine driving device according to the invention is for operating a working unit by a plurality of hydraulic actuator systems and comprises an engine, a power transmission device connected to the engine, a motor generator, which is connected to the power transmission device and has functions of both a motor and a power generating device, a power storage device for storing the electric power generated by the motor generator and supplying the motor generator with electric power, a pump motor connected to the power transmission device, pumps, which are connected to the power transmission device and adapted to be driven by either one of or both the engine and the motor generator, a plurality of driving circuits respectively provided for the hydraulic actuator systems, and one or more supporting circuits. The pump motor has functions of both a pump, which is adapted to be driven by either one of or both the engine and the motor generator, and a hydraulic motor for driving the motor generator. Each driving circuit is adapted to be operated by hydraulic fluid supplied from either one of or both the pump motor and the corresponding pump, thereby driving the corresponding hydraulic actuator system, and recover back to the tank and return to either one of or both the pump motor and the corresponding pump the hydraulic fluid returned from the hydraulic actuator system. Each supporting circuit serves to feed supporting hydraulic fluid from one driving circuit to another driving circuit to make up shortfall in the hydraulic fluid. The engine operates under a given, constant load. When the amount of power required by the hydraulic actuators is small, the excess engine power is converted to electric energy by the motor generator and charged on the power storage device. When the power required by the hydraulic actuators exceeds the output of the engine, the electric power stored in the power storage device is supplied to the motor generator so that the motor generator functions as the motor. Furthermore, as the supporting circuits enable the plurality of driving circuits to effectively share excess energy generated from hydraulic fluid so that the capacities of the pump motor and the pumps can be reduced, the pump motor and the pumps can be made compact, resulting in reduction of their production costs. As either one of or both the pump motor and the pumps can be driven by either one of or both the engine and the motor generator by means of the power transmission device, the number of expensive motor for driving the pumps can be reduced, resulting in reduced production costs.

A work machine driving device according to yet another feature of the invention is characterized in that at least one common driving circuit is connected to a plurality of parallelly arranged hydraulic actuators. The work machine driving device having this feature enables the reduction of the number of driving circuits with respect to the number of hydraulic actuator systems, thereby reducing the production cost of the driving device.

The power storage device of a work machine driving device according to yet another feature of the invention includes a capacitor and a battery. The capacitor is capable of instantaneous charge or discharge of electricity, and the battery is capable of charge or discharge of electricity over a relatively extensive period of time.

Each tank of a work machine driving device according to yet another feature of the invention is pressurized by means of a pressure accumulator. Pressurizing each tank by the pressure accumulator increases the pressure at the intake side of the pump and thereby prevents formation of cavitation in the tank. This feature makes it possible to use a small-size pump and rotate it at a high speed.

A work machine driving device according to yet another feature of the invention is characterized in that the hydraulic actuator systems include a boom cylinder system for operating a boom of a hydraulic shovel, a stick cylinder system for operating a stick, and a bucket cylinder system for operating a bucket; the driving circuits include a driving circuit for driving the boom cylinder system, a driving circuit for driving the stick cylinder system, and a driving circuit for driving the bucket cylinder system; and that the supporting circuits are provided for the line from the boom cylinder driving circuit to the stick cylinder driving circuit, the line from the bucket cylinder driving circuit to the boom cylinder driving circuit, and the line from the bucket cylinder driving circuit to the stick cylinder driving circuit, respectively. With the configuration as above, in the excavation mode during excavation operation by the hydraulic excavator, supporting hydraulic fluid can be fed from the driving circuit for the boom cylinders, which requires a relatively low hydraulic fluid flow rate, to the driving circuit for the stick cylinder; in the turn-and-raise mode, supporting hydraulic fluid can be fed from the driving circuit for the bucket cylinder, which requires a relatively low hydraulic fluid flow rate, to the driving circuit for the boom cylinders, which is in need of flow rate; and in the turn-and-lower mode, supporting hydraulic fluid can be fed from the driving circuit for the bucket cylinder, which requires a relatively low hydraulic fluid flow rate, to the driving circuit for the stick cylinder, which is in need of flow rate.

### BRIEF DESCRIPTION OF THE DRAWINGS

FIG. 1 is a circuit diagram showing an embodiment of a work machine driving device according to the present invention;

FIG. 2 is a circuit diagram showing in detail a hydraulic circuit of the driving device;

FIG. 3 is a side view of an example of an actuator driving unit of the driving device;

FIG. 4 is a circuit diagram showing another embodiment of a work machine driving device according to the present invention;

FIG. 5 is a circuit diagram showing a further embodiment of a work machine driving device according to the present invention;

FIG. 6 is a circuit diagram showing a further embodiment of a work machine driving device according to the present invention;

FIG. 7 is a circuit diagram showing in detail a hydraulic circuit of the driving device;

FIG. 8 is a circuit diagram showing a further embodiment of a work machine driving device according to the present invention;

FIG. 9 is a side view of a hydraulic excavator; and

FIG. 10 is a circuit diagram showing the structure of a conventional hydraulic system of a hydraulic excavator.

### DETAILED DESCRIPTION OF THE PREFERRED EMBODIMENTS OF THE INVENTION

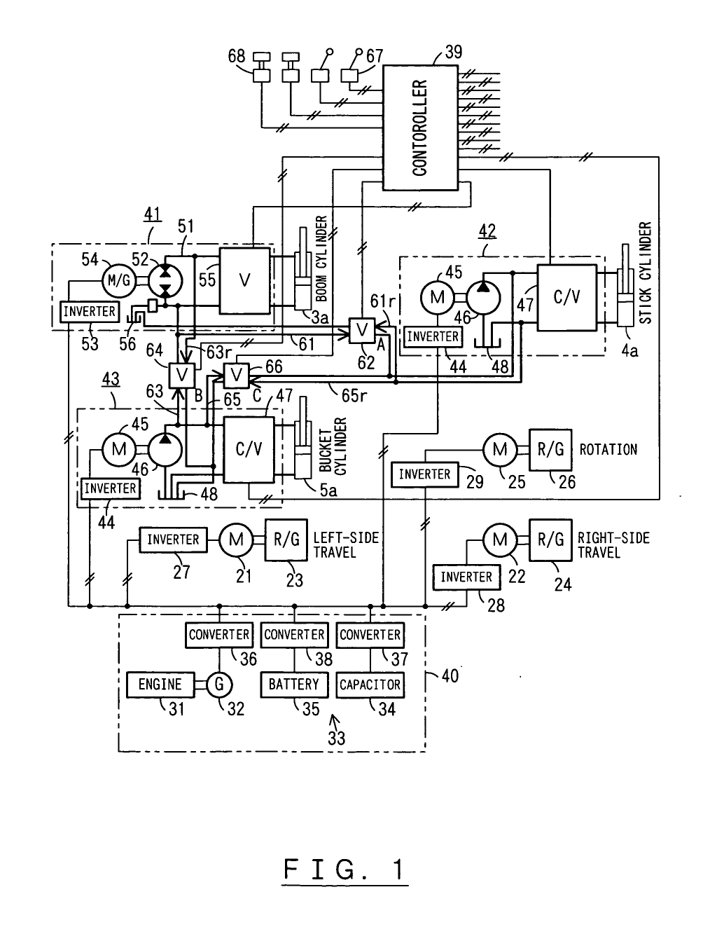

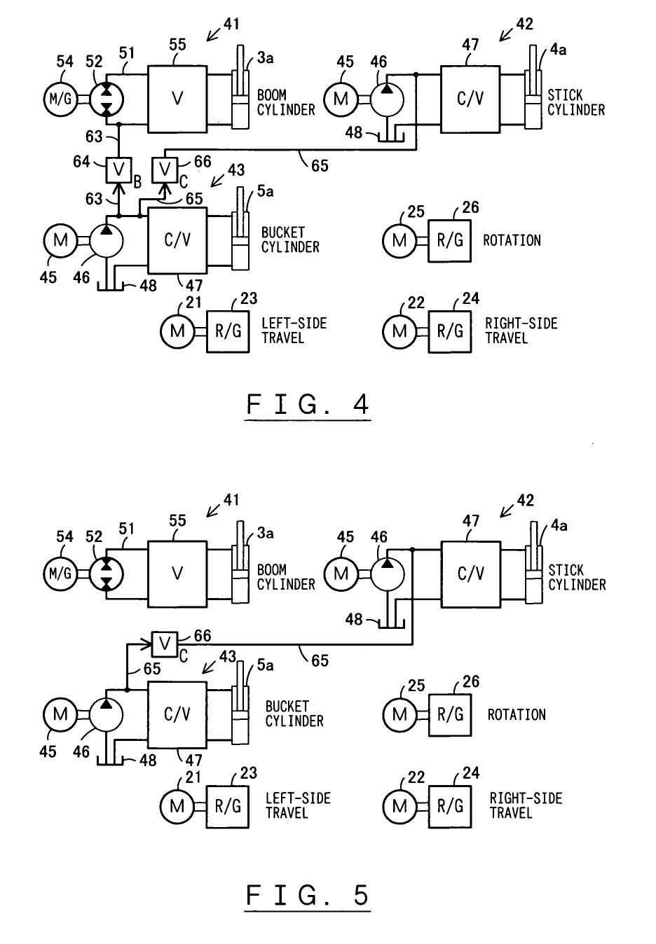

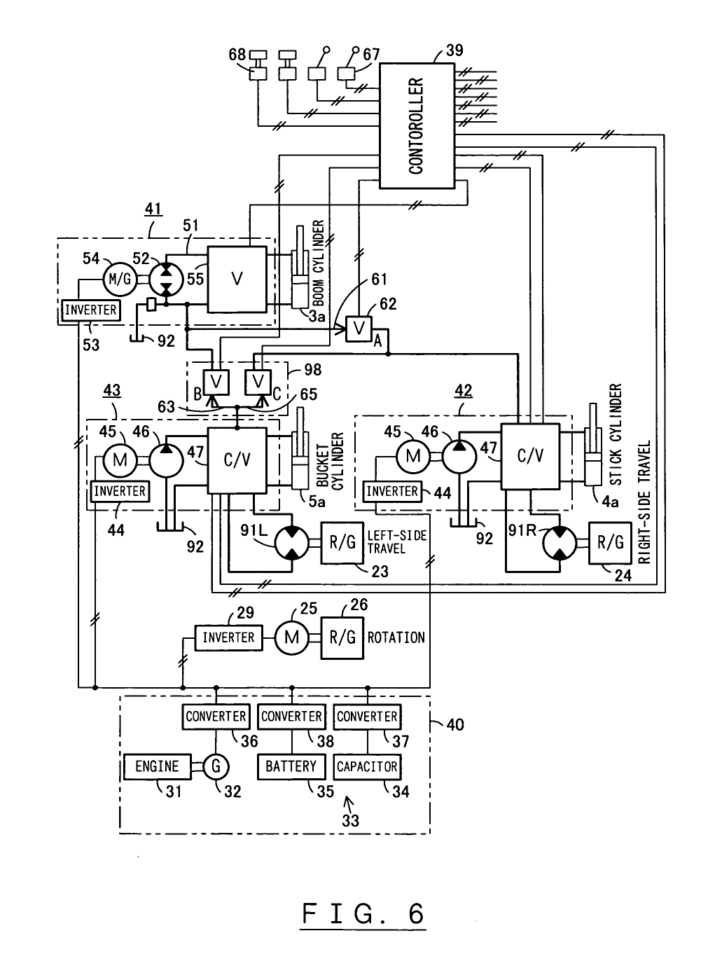

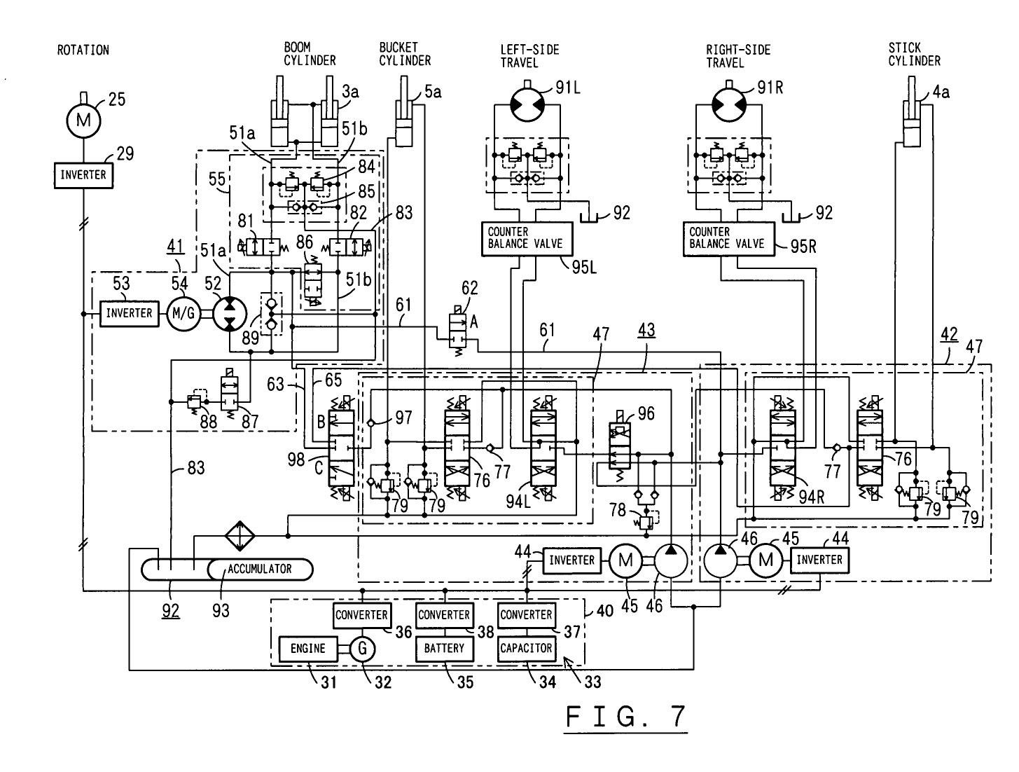

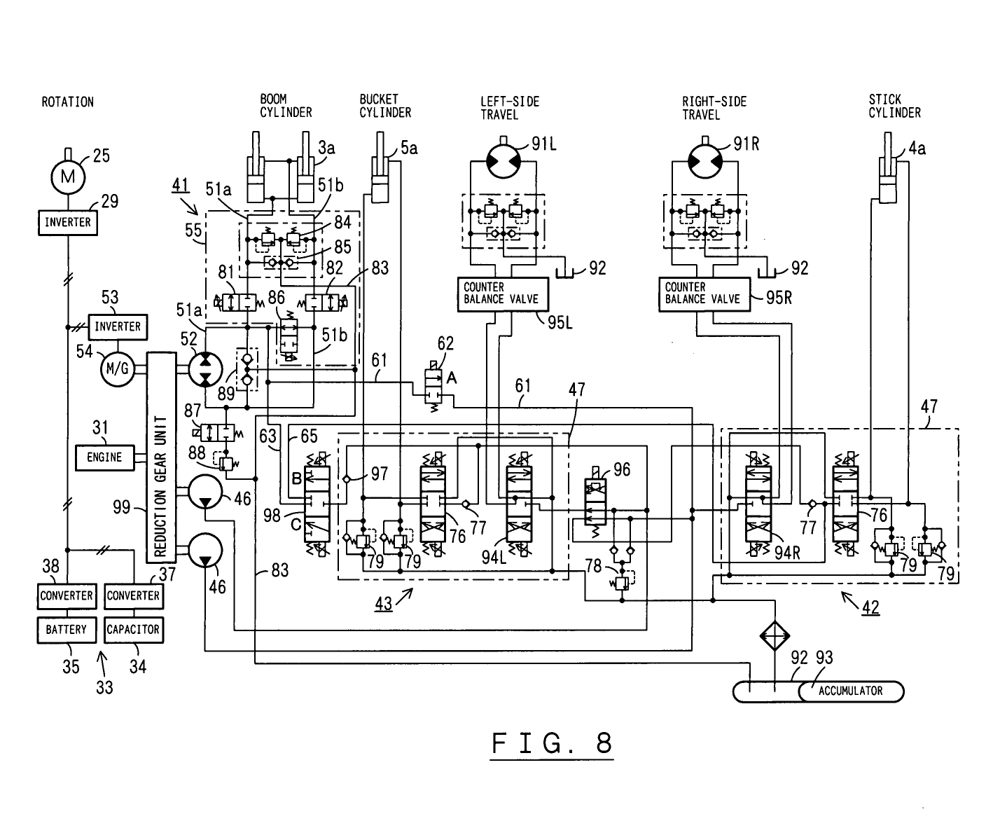

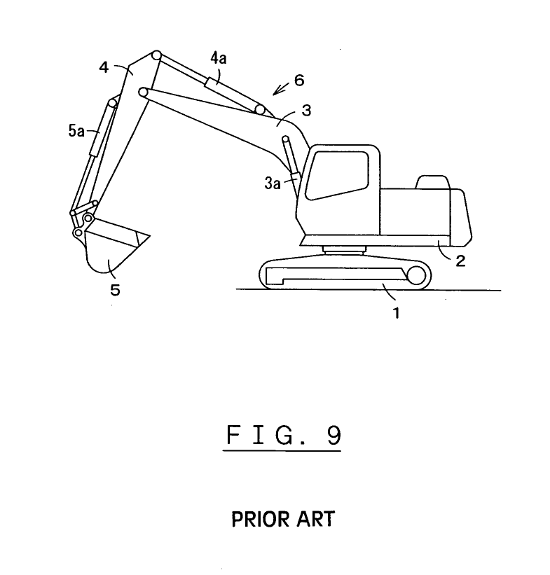

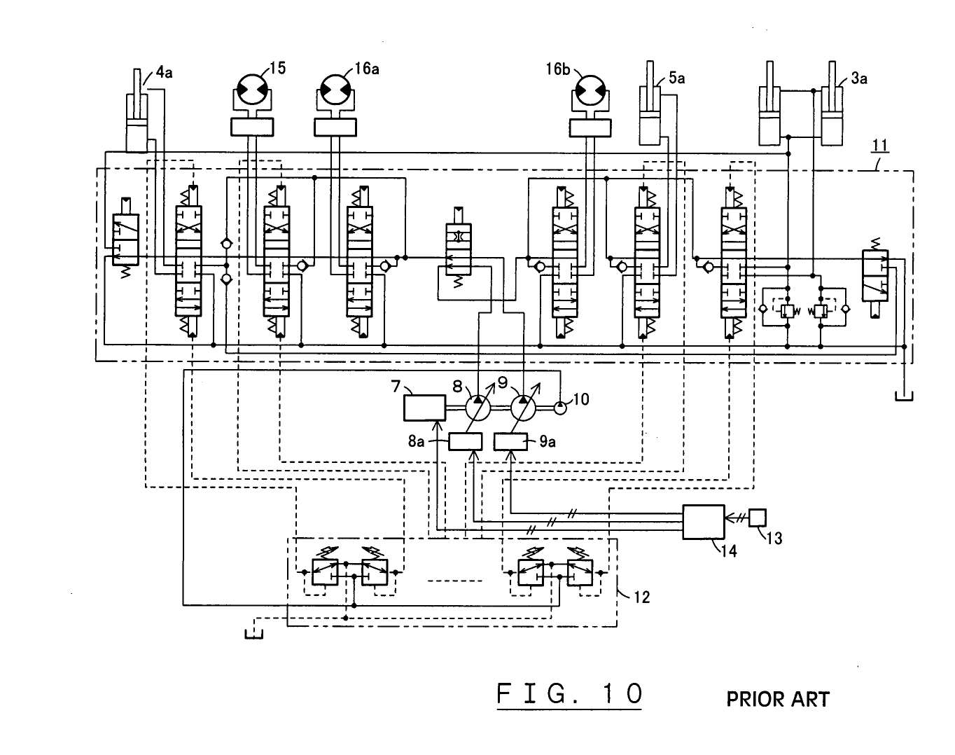

The present invention is explained in detail, referring to an embodiment shown in FIGS. 1 through 3, another embodiment shown in FIG. 4, and a further embodiment shown in FIG. 5, other embodiments are shown in FIGS. 6 and 7, and another embodiment is shown in FIG. 8. The explanation of the hydraulic excavator shown in FIG. 9 is also used in the explanation of the present embodiments.

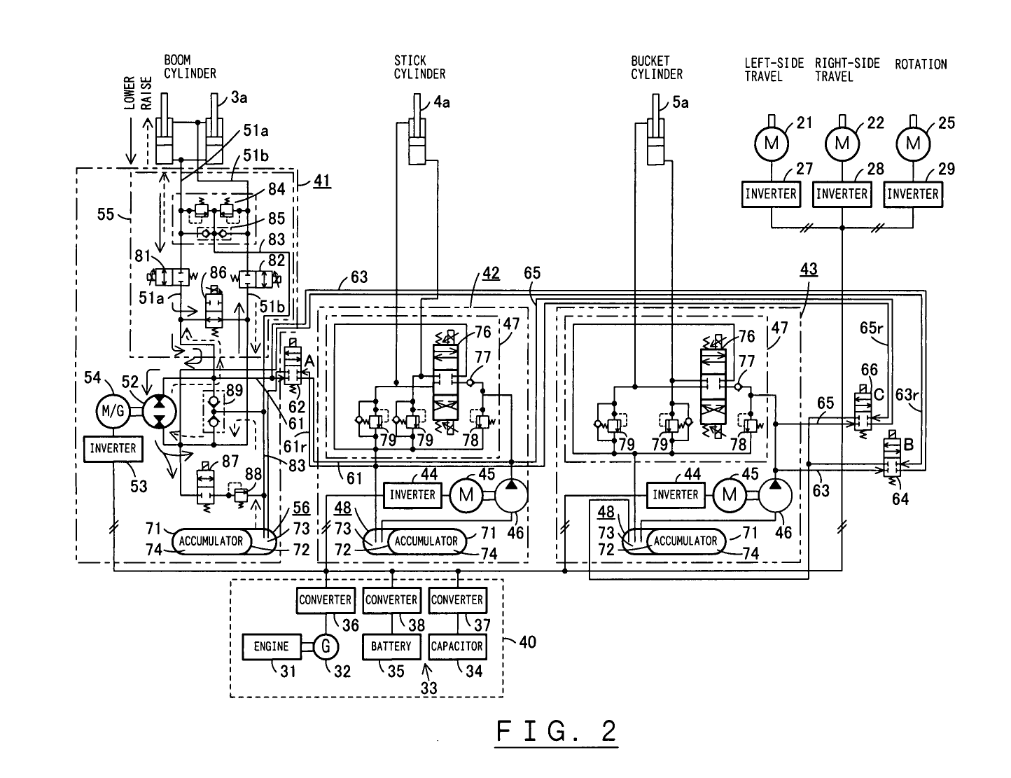

FIG. 1 shows an embodiment of a driving device of a work machine, which is a construction machine, or more precisely, a hydraulic excavator. As shown in FIG. 9, the hydraulic excavator has a working unit 6 comprising a boom 3, a stick 4, and a bucket 5 that are connected sequentially. Shown in FIG. 1 is a circuit diagram of a composite hybrid driving device of the hydraulic excavator. The driving device includes a boom-stick-bucket composite circuit. FIG. 2 shows a circuit diagram that illustrates the circuit diagram of FIG. 1 in more concrete terms.

As shown in FIG. 1, the working unit 6 of the hydraulic excavator are operated by a plurality of actuators. These actuators are hydraulic cylinders that are fluid pressure actuators to be operated by oil pressure, (i.e. working oil) which is pressurized working fluid. The actuators comprise boom cylinders 3a for operating a boom, a stick cylinder 4a for operating a stick and a bucket cylinder 5a for operating a bucket.

The right and left traveling actuators for turning the right and left crawler belts of the under carriage 1 of the hydraulic excavator are motors 21,22; the motors 21,22 operate the right and left crawler belts by means of reduction gear mechanisms 23,24, respectively.

The turning actuator for rotating the upper structure 2 on the undercarriage 1 is a motor 25. The motor 25 operates the upper structure 2 by means of a reduction gear mechanism 26.

The direction and speed of rotation of each motor 21,22,25 are controlled by each respective inverter 27,28,29.

An engine 31, a power generator 32, which serves as a power generating device driven by the engine 31, and a power storage device 33 for storing the electric power generated by the power generator 32 are mounted on the upper structure 2.

The aforementioned power storage device 33 is provided with a capacitor 34 for instantaneous charge or discharge of electricity and a battery 35 for charge or discharge of electricity over a relatively extensive period of time.

A converter 36 for controlling the voltage of the power generator 32 is connected to the power generator 32. Converters 37,38 are respectively connected to the capacitor 34 and the battery 35 so as to control electric charge on and discharge from the capacitor 34 and battery 35. The converters 36,37,38 are connected to a controller 39, which controls outputs from the power generator 32, the capacitor 34 and the battery 35 based on a load.

The engine 31, the power generator 32, the capacitor 34, the battery 35, and the converters 36,37,38 together function as a power source unit 40.

A driving circuit 41 for driving the boom cylinders 3a is provided. In order to drive the boom cylinders 3a, the driving circuit 41 is adapted to be operated by means of oil hydraulics generated by electric power supplied from either one of or both the power generator 32 and the power storage device 33.

A driving circuit 42 for driving the stick cylinder 4a is provided. In order to drive the stick cylinder 4a, the driving circuit 42 is adapted to be operated by means of oil hydraulics generated by electric power supplied from either one of or both the power generator 32 and the power storage device 33.

A driving circuit 43 for driving the bucket cylinder 5a is provided. In order to drive the bucket cylinder 5a, the driving circuit 43 is adapted to be operated by means of oil hydraulics generated by electric power supplied from either one of or both the power generator 32 and the power storage device 33.

Each one of the driving circuits 42,43, which serves to respectively drive the stick cylinder 4a and the bucket cylinder 5a, includes an electric motor 45, a pump 46 to be driven by the electric motor 45, a valve unit 47, and a tank 48. The electric motor 45 is a motor to be operated by electric power supplied from either one of or both the power generator 32 and the power storage device 33. The rotation speed of each electric motor 45 is controlled by an inverter 44. Each valve unit 47 is adapted to control the direction of the hydraulic oil discharged from the pump 46 so as to feed the hydraulic oil to the corresponding cylinder, i.e. the stick cylinder 4a or the bucket cylinder 5a. The hydraulic oil that has been supplied from each pump 46 to either the stick cylinder 4a or the bucket cylinder 5a is recovered and returned to the pump 46 through each respective tank 48.

The driving circuit 41 for the boom cylinders 3a includes a closed circuit 51, a bidirectional pump motor 52 and a motor generator 54. The pump motor 52 is provided in the closed circuit 51 and functions as both a pump for supplying hydraulic oil and a hydraulic motor adapted to operate by receiving hydraulic oil. The motor generator 54 functions as both a motor and a power generating device. The motor function of the motor generator 54 serves to drive the pump motor 52 and is adapted to be operated by electric power supplied from either one of or both the power generator 32 and the power storage device 33, with the direction and speed of its rotation controlled by an inverter 53. The power generation function of the motor generator 54 is adapted to be driven by the pump motor 52 so as to generate electric power.

A valve unit 55 to be described later is provided in the closed circuit 51. When the boom is lowered, the flow rate of the return oil discharged from the head-side exceeds that of the hydraulic oil fed into the rod-side of each boom cylinder 3a, necessitating discharge of the excess oil from the closed circuit 51. When the boom is raised, the flow rate of the hydraulic oil becomes insufficient at the intake side of the pump motor 52. Therefore, in order to recover the excess oil or make up the shortage, the closed circuit 51 is provided with a tank 56.

Any one of the aforementioned motors, i.e. the motors 21,22 for the traveling system, the motor 25 for the turning system, the electric motors 45 for the stick and bucket systems, and the motor generator 54 for the boom system may be an AC motor or a DC motor.

The driving device according to the invention is also provided with supporting circuits, each of which serves to feed hydraulic fluid from one driving circuit to another driving circuit to make up a shortage in the hydraulic fluid.

For example, the driving device includes a supporting circuit 61 for feeding hydraulic oil from the closed circuit 51 of the driving circuit 41 of the boom cylinders 3a to the pump discharge side of the driving circuit 42 of the stick cylinder 4a, and a supporting return circuit 61r for feeding hydraulic oil in the reverse direction. A supporting valve 62 is provided in the supporting circuit 61 as well as the supporting return circuit 61r so as to open or close these circuits.

In the same manner as above, the driving device includes a supporting circuit 63 for feeding hydraulic oil from the pump discharge side of the driving circuit 43 of the bucket cylinder 5a to the closed circuit 51 of the driving circuit 41 of the boom cylinders 3a, and a supporting return circuit 63r for feeding hydraulic oil in the reverse direction. A supporting valve 64 is provided in the supporting circuit 63 as well as the supporting return circuit 63r so as to open or close these circuits.

The driving device also includes a supporting circuit 65 for feeding hydraulic oil from the pump discharge side of the driving circuit 43 of the bucket cylinder 5a to the pump discharge side of the driving circuit 42 of the stick cylinder 4a, and a supporting return circuit 65r for feeding hydraulic oil in the reverse direction. A supporting valve 66 is provided in the supporting circuit 65 as well as the supporting return circuit 65r so as to open or close these circuits.

With the configuration as above, occurrence of imbalance in the amount of hydraulic oil in the plurality of tanks 48,48,56 can be prevented by each supporting return circuit 61r,63r,65r recovering the supporting hydraulic oil that has been fed from one driving circuit to another driving circuit by each respective supporting circuit 61,63,65.

Referring to FIG. 1, electric operating devices 67,68, each of which may be operated by a lever or a pedal, are connected to the aforementioned controller 39 so that an operating signal input from each operating device 67,68 to the controller 39 undergoes calculation processing by the controller 39 and that the control signal resulting from the processing is output from the controller 39 to the inverters 44,53, the valve units 47,55, the supporting valves 62,64,66, and/or any other relevant components.

As shown in FIG. 2, each tank 48,56 is pressurized by a pressure accumulator 71. To be more specific, each tank 48,56 has an accumulator structure which includes a tightly closed pressure container. The interior of the pressure container is divided by an elastic partition film member 72 into an oil chamber 73 and a gas chamber 74 so that compressed gas sealed in the gas chamber 74 applies pressured to the hydraulic oil in the oil chamber 73, which communicates with the intake port of the corresponding pump 46 or pump motor 52.

In cases where a combination of small electric motor 45 and pump 46 or a combination of small pump motor 52 and motor generator 54 is used at a high speed, cavitation is likely to occur at the intake side of the pump 46 or the pump motor 52. Therefore, in order to prevent such cavitation, it is necessary to provide each tank 48,48,56 with an accumulator 71 for increasing the pressure at the intake side of the corresponding pump 46 or pump motor 52.

The discharge rate of the hydraulic oil from each pump 46, i.e. the pump 46 for the stick system or the bucket system, is controlled by means of the rotation speed of each respective electric motor 45. When the stick cylinder 4a or the bucket cylinder 5a is not going to be operated, the rotation speed of the corresponding electric motor 45 is set at 0 rpm so that the hydraulic oil discharge rate of the corresponding pump 46 is 0.

In the same manner as above, the hydraulic oil discharge rate of the bi-directional pump motor 52 is controlled by means of the rotation speed of the motor of the motor generator 54. The direction of pump discharge from the pump motor 52 is controlled by means of the rotation direction of the motor of the motor generator 54. in other words, when changing the direction of pump discharge, the direction of rotation of the motor of the motor generator 54 is changed.

The supporting valve 62, 64, 66 of each supporting circuit 61, 63, 65 is a valve adapted to open or close by receiving at its solenoid an ON/OFF signal from the controller 39. When the valve is opened by an ON signal, its supporting function is activated so that hydraulic fluid is fed from one driving circuit to another driving circuit.

Each one of the valve units 47 that are respectively included in the stick driving circuit 42 and the bucket driving circuit 43 has a valve body, in which a directional control valve 76, a load hold check valve 77 and relief valves 78,79 are provided. The directional control valve 76 serves to change over the circuit for extending or contracting the cylinder. The load hold check valve 77 is provided at the hydraulic oil receiving side of the directional control valve 76. The relief valve 78 is used for setting pump discharge pressure. The relief valve 79 is provided at the hydraulic oil output side of the directional control valve 76 and used for setting circuit pressure.

In order to limit the pressure loss, each directional control valve 76 is normally used in a fully open state. Upon receiving an ON/OFF signal from the controller 39, the solenoid of the directional control valve 76 switches the valve from a neutral position to a fully open position at one side or a fully open position at the other side. However, should the pressure at the support target, to which the hydraulic oil is to be fed, be high when a supporting valve 64, 66 is performing its supporting function, the directional control valve 76 of the supporting valve 64, 66 is throttled by means of a linear signal so as to generate pressure higher than the pressure at the support target.

The boom driving circuit 41 is provided with electromagnetic control valves 81,82, which are respectively disposed in a head-side channel 51a and a rod-side channel 51b of the closed circuit 51. A relief valve 84 and a check valve 85 are provided closer to the boom cylinders 3a than are the control valves 81,82. The relief valve 84 serves to release into a tank channel 83 excessive pressure that is in the head-side channel 51a or the rod-side channel 51b and exceeds a set level. The check valve 85 serves to feed oil from the tank channel 83 into the head-side channel 51a or the rod-side channel 51b to make up shortfall in oil.

In order to limit the pressure loss, each control valve 81, 82 is normally used in a fully open state when the boom cylinders 3a are operated. Upon receiving an ON signal from the controller 39, the solenoid of the control valve 81, 82 switches the valve from a fully closed position to a fully open position. However, should the pressure at the support target, to which the hydraulic oil is to be fed, be high when the supporting valve 62 is performing its supporting function, each control valve 81, 82 is narrowed by means of a linear signal so as to generate pressure higher than the pressure at the support target.

An electromagnetic regeneration valve 86, an electromagnetic discharge valve 87, a relief valve 88 and a check valve 89 are provided closer to the pump motor 52 than are the control valves 81,82. The regeneration valve 86 serves to communicates the head-side channel 51a with the rod-side channel 51b so as to regenerate a part of the return oil from the head-side of each boom cylinder 3a to the rod side. The discharge valve 87 and the relief valve 88 serve to discharge excess oil from the rod-side channel 51b to the tank channel 83. The check valve 89 serves to feed oil from tank channel 83 into the head-side channel 51a or the rod-side channel 51b to make up shortfall in oil.

When the boom is lowered, the amount of the return oil flowing out of the head-side of each boom cylinder 3a exceeds the amount of the hydraulic oil flowing into the rod-side, necessitating the boom driving circuit 41 to discharge the excess oil from the closed circuit 51. Therefore, as shown by solid-line arrows in FIG. 2, the oil other than the amount needed at the rod-side each boom cylinder 3a is returned from the rod-side channel 51b through the discharge valve 87 and the relief valve 88 into the tank 56. When the boom is raised, the amount of the hydraulic oil becomes insufficient at the intake side of the pump motor 52. Therefore, as shown as shown by broken-line arrows in FIG. 2, the shortfall in oil is made up for by pumping the hydraulic oil from the tank 56 into the rod-side channel 51b through the tank channel 83 and the check valve 89.

Each driving circuit 41,42,43 is integrated with the corresponding cylinder or cylinders, i.e. the boom cylinders 3a, the stick cylinder 4a or the bucket cylinder 5a, so as to form an actuator driving unit.

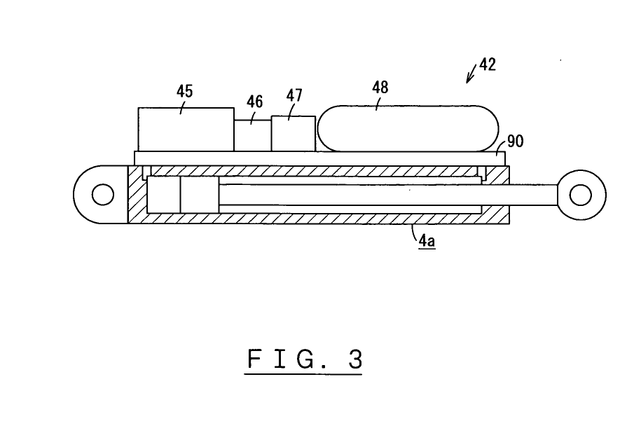

For example, FIG. 3 shows an example of an actuator driving unit that integrates the stick cylinder 4a with the driving circuit 42. To be more specific, the driving circuit 42, which includes the electric motor 45, the pump 46, the valve unit 47, and the tank 48, is integrated with the stick cylinder 4a, with a manifold plate 90 disposed between the stick cylinder 4a and the driving circuit 42.

The pump 46, the valve unit 47, the tank 48, and the stick cylinder 4a communicates with one another through a passage provided inside the manifold plate 90.

In addition to the driving circuit 41,42,43, each supporting circuit 61,64,65 may be integrated with the corresponding cylinder or cylinders.

Next, the functions and effects of the boom-stick-bucket composite circuit shown in the FIGS. 1 through 3 are explained hereunder.
(1) Outline of Operations

The engine 31 operates under a given, constant load. When the total motor power consumed by the motors 21,22,25,45 and the motor generator 54 is less than the output of the engine 31, the electric power output from the power generator 32 is charged on the capacitor 34 or the battery 35.

When the total motor power consumed by the motors 21,22,25,45 and the motor generator 54 exceeds the output of the engine 31, the electric power stored in the capacitor 34 or the battery 35, as well as the power output from the power generator 32, is supplied as the motor power source for the motors 21,22,25,45 and the motor generator 54.

The present driving device calls for driving the driving circuits 41,42,43 for the respective actuator systems independently from one another and providing the supporting circuits 61,63,65 for feeding hydraulic oil from the boom driving circuit 41 to the stick driving circuit 42 or from the bucket driving circuit 43 to the boom driving circuit 41 and the stick driving circuit 42 to make up shortfall in the flow rate of the hydraulic oil. Only when support feeding of hydraulic oil is necessary does the supporting circuit 61,63,65 that is necessary for support feeding open its supporting valve 62,64,66 so as to feed hydraulic oil to the support target.

The capacity of each driving circuit 41,42 for the boom system or the stick system is limited to an approximately half of the power and flow rate required by the corresponding actuator system in order to make the entire circuit compact. When power or flow rate exceeding its capacity is needed, the driving circuit receives support from either one of or both the driving circuits 41,43 for the other systems.

To be more specific, with respect to a command value, which is an operating signal input from the electric operating device 67 or 68 in terms of the amount of action to operate the electric operating device, i.e. 0-100%, the capacity of each driving circuit 41,42 for the boom system or the stick system is limited to approximately 50%. Should the corresponding operating device 67,68 be operated to a degree that exceeds the capacity of the driving circuit, support is given from the driving circuit 41,43 of another actuator system.

For example, dump/load operation may be divided into four categories: excavation, turn-and-raise, dumping, and turn-and-lower. The average power necessary for each respective category of operation is shown in Table 1 below. It should be noted that the following is merely an example. Any value shown in the table may vary. 100% represents the maximum driving power.

TABLE 1

| | Boom | Stick | Bucket | Swing |
|---|---|---|---|---|
| Excavation | 0-10% | 0-60% | 0-30% | — |
| | (Support A→) | (↑) | | |
| Turn-and- | 0-70% | 0-50% | 0-50% | 0-20% |
| raise | (↑) | ( [symbol] ) | ( [symbol] Support B) | |
| Dumping | 0-50% | 0-10% | 0-20% | — |
| Turn-and- | Approx. 0% | 0-20% | Approx. 0% | 0-20% |
| lower | (Regeneration) | (↑) | ( [symbol] Support C) | |

As is evident from Table 1;

When excavation is performed, the stick system requires power and speed, while the bucket system, too, needs considerable power and speed. However, the boom system does not require so much power. Therefore, the supporting valve 62 is opened to feed supporting hydraulic oil from the boom system to the stick system.

When turn-and-raise is performed, the boom system requires power and speed, while neither the stick system or the bucket system requires much power. Therefore, the supporting valve 64 is opened to feed supporting hydraulic oil from the bucket system to the boom system.

When dumping is performed, support is not necessary.

When turn-and-lower is performed, the boom 3 descends by its own weight so that the regeneration valve 86 can be opened to drive the boom cylinders 3a by the regeneration function, with the power being approximately 0. At that time, as the bucket 5 is hardly moved, the supporting valve 66 is opened to feed supporting hydraulic oil from the bucket system to the stick system.
(2) Effects

As described above, in the excavation mode during excavation operation by a hydraulic excavator, supporting hydraulic oil can be fed from the driving circuit 41 for the boom cylinders 3a, which has a relatively low flow rate requirement, to the driving circuit 42 for the stick cylinder 4a by means of the supporting circuit 61. In the turn-and-raise mode, supporting hydraulic oil can be fed from the driving circuit 43 for the bucket cylinder 5a, which has a relatively low flow rate requirement, to the driving circuit 41 for the boom cylinders 3a, which is in need of flow rate, by means of the supporting circuit 63. In the turn-and-lower mode, supporting hydraulic oil can be fed from the driving circuit 43 for the bucket cylinder 5a, which has a relatively low flow rate requirement, to the driving circuit 42 for the stick cylinder 4a, which is in need of flow rate, by means of the supporting circuit 65.

In cases where the driving circuits 41,42,43 are provided as separate circuits that operate independently from one another, each one of the driving circuit 41 for the boom cylinders 3a and the driving circuit 42 for the stick cylinder 4a requires the ability to provide the corresponding cylinder(s) with nearly 100% of the necessary power and speed. However, the provision of the supporting circuits 61,63,65 enables the ability required of each respective driving circuit 41,42 to be nearly halved.

Therefore, even with the increase in the cost due to the supporting valves 62,64,66 and other relevant components of the supporting circuits being deducted, the production cost for the entire system can be reduced. In addition, the components of the driving circuits can be made compact.

As shown in FIG. 3, the reduction in the sizes of the components of the driving circuits makes it possible to integrate each one of the stick cylinder 4a and the bucket cylinder 5a with the electric motor 45, the pump 46, the valve unit 47 and the tank 48 of the corresponding driving circuit 42,43 and also integrate the boom cylinders 3a with the pump motor 52, the motor generator 54, the valve unit 55 and the tank 56 of the corresponding driving circuit 41.

As described above, integration of each driving circuit 41,42,43 with each respective hydraulic actuator system reduces the loss resulting from the piping of each driving circuit 41,42,43 and also eliminates the necessity of the space for installation of the driving circuits on the machine body, i.e. on the upper structure 2.

Should a driving circuit system have the ability to produce 100% power, the increased size and weight of each component, such as a motor or a pump, of the system would make it difficult to mount on an actuator.

To summarize, the supporting circuits 61,63,65 enable the plurality of driving circuits 41,42,43 to effectively share excess energy generated from hydraulic fluid so that the capacity of each driving circuit 41,42,43, which is adapted to generate hydraulic pressure by being operated by electricity supplied from the generator 32 or the power storage device 33, both of which are driven by the engine 31, can be consequently reduced. Therefore, the inclusion of the supporting circuits 61,63,65 enables the various components of the driving circuits 41,42,43 to be made compact at reduced production costs.

According to the embodiment described above, the controller 39 controls the rotation speed of each electric motor 45 or the motor generator 54 by means of each respective inverter 44,53, thereby enabling the control of the flow rate of hydraulic oil discharge from each pump 46 or the pump motor 52. In other words, it is not necessary for each valve unit 47,55 to throttle the circuit in order to control the flow rate. Therefore, the pressure loss caused by the valve units 47,55 can be reduced. As the throttle loss that would be caused by flow control by control valves and piping of a conventional system is eliminated, the embodiment described above limits unnecessary heat generation or otherwise improves the energy efficiency.

The motor generator 54, which has a function as a motor, drives the pump motor 52 in the closed circuit 51 so that the pump motor 52 operates as a pump. Therefore, when operating the boom cylinders 3a, the direction of action of the boom cylinders 3a can be controlled by selecting the discharge direction from the pump motor 52, which is of a bi-directional type.

When the boom cylinders 3a are operated by an external load, such as the weight of the working unit 6 itself, the boom cylinders 3a function as a pump so that hydraulic pressure is generated in the closed circuit 51 and operates the pump motor 52 as a hydraulic motor. As a result, the motor generator 54, which is driven by the pump motor 52, functions as a power generating device so as to generate electric power. The power generated by the motor generator 54 is charged on the capacitor 34 and the battery 35 of the power storage device 33. This feature of the embodiment reduces the burden imposed on the engine 31 and enables the effective use of excess energy.

Each motor, i.e. the electric motors 45 or the motor generator 54, is either an AC motor or a DC motor. For example, a small-size AC motor may be used, in order to integrate an electric motor 45 or the motor generator 54 into cylinder systems in a space-efficient manner. However, it is also possible to use a DC motor for any one of these electric motors 45 and motor generator 54.

The power storage device 33 includes the capacitor 34 and the battery 35 so that the capacitor 34 is capable of instantaneous charge or discharge of electricity and that the battery 35 is capable of charge or discharge of electricity over a relatively extensive period of time. Therefore, the power storage device 33 according to the invention ensures superior electricity storage capacity.

Pressurizing each tank 48,56 by means of a pressure accumulator 71 increases the pressure at the intake side of each respective pump 46 or pump motor 52 and thereby prevents the generation of cavitation in the tanks 48,56 or the pump motor 52. As a result, a small-size pump 46 or pump motor 52 may be used and rotated at a high speed.

FIG. 4 is a circuit diagram showing another embodiment of a work machine driving device according to the present invention. The embodiment differs from the previous embodiment shown in FIG. 1 in that the supporting circuit 61 for feeding supporting hydraulic oil from the driving circuit 41 for the boom cylinders 3a to the driving circuit 42 for the stick cylinder 4a is eliminated and that the work machine driving device includes a supporting circuit 63 for feeding supporting hydraulic oil from the pump discharge side of the driving circuit 43 for the bucket cylinder 5a to the driving circuit 41 for the boom cylinders 3a and a supporting circuit 65 for feeding supporting hydraulic oil from the pump discharge side of the driving circuit 43 for the bucket cylinder 5a to the driving circuit 42 for the stick cylinder 4a. The elements corresponding to those in FIG. 1 are identified with the same reference characters, with the explanation thereof being omitted. Furthermore, the supporting return circuits 63r,65r shown in FIG. 1 are not shown in FIG. 4.

The embodiment shown in FIG. 4 is characterized in that supporting hydraulic oil is fed to the driving circuit 42 for the stick cylinder 4a only from the driving circuit 43 for the bucket cylinder 5a. When supporting hydraulic oil is fed, for example, from the bucket system only to the stick system during excavating action, the boom cylinders 3a and the bucket cylinder 5a are slightly slowed down. However, this does not affect the efficiency of the excavation. As supporting hydraulic oil is fed only from the bucket system, the circuit configuration is simplified, and control of the supporting valves 64,66 is facilitated.

Next, FIG. 5 is a circuit diagram showing a further embodiment of a work machine driving device according to the present invention. The previous embodiment differs from the embodiment shown in FIG. 1 in that the supporting circuit 61, which serves to feed supporting hydraulic oil from the driving circuit 41 for the boom cylinders 3a to the driving circuit 42 for the stick cylinder 4a, and the supporting circuit 63, which serves to feed supporting hydraulic oil from the driving circuit 43 for the bucket cylinder 5a to the driving circuit 41 for the boom cylinders 3a, are eliminated, and that a supporting circuit 65 for feeding supporting hydraulic oil from the pump discharge side of the driving circuit 43 for the bucket cylinder 5a to the driving circuit 42 for the stick cylinder 4a is provided. The elements corresponding to those in FIG. 1 are identified with the same reference characters, with the explanation thereof being omitted. Furthermore, the supporting return circuit 65r shown in FIG. 1 is not shown in FIG. 5.

The embodiment shown in FIG. 5 characterized in that supporting hydraulic oil is fed only from the driving circuit 43 for the bucket cylinder 5a only to the driving circuit 42 for the stick cylinder 4a. When supporting hydraulic oil is fed, the working speed of the cylinders becomes slightly slower than that in the case of the embodiment shown in FIG. 4. However, as the sufficient working speed of the stick cylinder 4a is ensured, the efficiency of the excavating operation is not affected. As supporting hydraulic oil is fed only from the bucket system only to the stick system, the circuit configuration is further simplified, and control of the supporting valve 66 is facilitated further.

Next, FIG. 6 is a circuit diagram showing another embodiment of a work machine driving device according to the present invention, wherein the elements corresponding to those in FIG. 1 or FIG. 2 are identified with the same reference characters, with the explanation thereof being omitted.

The driving device shown in FIG. 6 is a composite hybrid driving device of the hydraulic excavator. The driving device includes a first working example of a boom-stick-bucket-travel composite circuit, wherein a plurality of hydraulic actuators are connected to common driving circuits in such a manner that the hydraulic actuators connected to each driving circuit are arranged in parallel.

To be more specific, the driving circuit 41 for the boom cylinders 3a and the driving circuit for the turning system, such as the motor 25 for turning the upper structure 2, of the driving device of the present embodiment are independent driving circuits. However, the driving circuit 42 serves as a common circuit, to which the stick cylinder 4a and a right-side travel motor 91R are connected in parallel with each other. The right-side travel motor 91R is a hydraulic motor that serves as a hydraulic actuator for the right-side travel. The driving circuit 43 serves as a common circuit, to which the bucket cylinder 5a and a left-side travel motor 91L are connected in parallel with each other. The left-side travel motor 91L is a hydraulic motor that serves as a hydraulic actuator for the left-side travel.

The working unit 6 is not often operated while the hydraulic excavator is running. In other words, the right and left travel motors 91R,91L are not usually operated simultaneously with the boom cylinders 3a, the stick cylinder 4a and the bucket cylinder 5a. Even if simultaneous operation is performed, its duration is not long. During simultaneous operation of the travel motors and the cylinders, the circuit configuration according to the present embodiment requires the directional control valve for the actuator with the lower pressure to be throttled in order to maintain an appropriate difference in driving pressure between the stick cylinder 4a and the right-side travel motor 91R for the right-side travel system or between the bucket cylinder 5a and the left-side travel motor 91L for the left-side travel system. However, as the duration of the simultaneous operation is not long, energy loss resulting from throttling the directional control valve is limited and does not cause significant reduction in the efficiency.

When performing excavation/loading or other operation that requires a great amount of power, the hydraulic excavator does not travel. Therefore, there is no possibility of occurrence of the aforementioned problem that would result from simultaneous operation of the actuators.

As the functions of the boom cylinders 3a, the stick cylinder 4a, and the bucket cylinder 5a are the same as those of the boom-stick-bucket composite circuit shown in FIG. 1, their explanation is omitted herein.

As a plurality of hydraulic actuators are connected to the common driving circuits 42,43 so that the hydraulic actuators connected to each driving circuit 42,43 are arranged in parallel, the number of driving circuits can be reduced with respect to the number of the hydraulic actuators so that the production cost of the driving device can be reduced.

For example, whereas the driving device shown in FIG. 1, which comprises independent driving circuits, require six driving circuits, the embodiment shown in FIG. 6 is able to reduce the number of the driving circuits to four by making the right and left travel systems share their respective driving circuits with the stick system and the bucket system. Thus, the embodiment shown in FIG. 6 enables cost reduction.

As the provision of the supporting circuits 61,63,65 reduces the ability required of each respective driving circuits 41,42 by nearly a half, the present embodiment can achieve similar effects to those offered by the configuration shown in FIG. 1.

FIG. 7 is a hydraulic circuit diagram showing in detail the composite hybrid driving device of the hydraulic excavator which includes the boom-stick-bucket-travel composite circuit shown in FIG. 6. An explanation is given hereunder only of the elements not shown in FIG. 6. The elements corresponding to those in FIG. 1 or FIG. 2 are identified with the same reference characters, with the explanation thereof being omitted.

The upper structure 2 is equipped with a single, large-size tank 92, which is provided separately from the cylinders. This is to facilitate the flow of hydraulic oil between the driving circuits 42,43 in order to ensure the ability to travel straight to be described later. The tank 92, too, is provided with a pressure accumulator 93. The present embodiment is similar to those described above in that the tank 92 may be pressurized by the pressure accumulator 93 to increase the pressure at the intake side of the pumps 46 and the pump motor 52, thereby preventing formation of cavitation and enabling high speed rotation of the small-size pumps 46 or the like.

As a result of changing the right and left travel systems from the electric circuits to the hydraulic circuits, the valve unit 47 of the driving circuit 42 includes a directional control valve 76 for the stick system and a directional control valve 94R for the right-side travel system. These valves 76,94R are connected, in parallel with each other, to a common pump 46. The stick cylinder 4a and the right-side travel motor 91R for the right-side travel of the hydraulic excavator are arranged in parallel with each other and connected to the pump 46 through the directional control valves 76,94R, respectively.

In the same manner as above, the valve unit 47 of the driving circuit 43 includes a directional control valve 76 for the stick system and a directional control valve 94L for the left-side travel system. These valves 76,94L are arranged in parallel with each other and connected to a common pump 46. The bucket cylinder 5a and the left-side travel motor 91L for the left-side travel of the hydraulic excavator are arranged in parallel with each other and connected to the pump 46 through the directional control valves 76,94L, respectively.

As described above, the circuit for the right-side travel and the circuit for the stick system are arranged in parallel with each other and connected to a common pump 46, and the circuit for the left-side travel and the circuit for the bucket system are in parallel with each other and connected to another common pump 46. Therefore, as a rule, each one of the directional control valves 76,94R and the directional control valves 76,94L is controlled to shift from the neutral position to a fully open position at one side or a fully open position at the other side. However, should a difference in pressure arise between these circuits, throttle differential pressure is generated in the directional control valve in the circuit with a lower pressure so that each actuator is provided with a required flow rate.

A counter balance valve 95R,95L for preventing runaway of the machine is provided in each travel circuit.

The driving circuit 43 is provided with a straight travel valve 96. By turning on the straight travel valve 96 while the hydraulic excavator is running, hydraulic oil discharged from right-side pump 46 alone is distributed to both directional control valves 94R,94L for the right and left-side travel. As this configuration maintains an equal balance in the circuit pressure between the right and left-side travel systems by preventing application of different discharge pressures from the two pumps 46 to the right and left-side travel systems respectively, the right and left travel motors 91R,91L are rotated at the same speed so as to ensure the ability to travel straight.

A supporting valve 98, which is a selector valve, is provided in a passage that is drawn from the driving circuit 43 including a directional control valve 76 for the bucket system. A check valve 97 is provided between the passage and the driving circuit 43. The function of the supporting valve 98 is equivalent to that of the two supporting valves 64,66 of the embodiment shown in FIGS. 1 and 2; the supporting valve 98 switched to the position B enables supporting hydraulic oil to flow from the driving circuit 43, which includes the bucket system, to the driving circuit 41 for the boom system, and the supporting valve 98 switched to the position C enables supporting hydraulic oil to flow from the driving circuit 43, which includes the bucket system, to the driving circuit 42 which includes the stick system.

According to this embodiment, too, the engine 31 operates under a given, constant load. In the same manner as in the case of the embodiment shown in FIGS. 1 and 2, when the total motor power consumed by the motors 25,45 and the motor generator 54 is less than the output of the engine 31, the electric power output from the power generator 32 is charged on the capacitor 34 or the battery 35, and when the total motor power consumed by the motors 25,45 and the motor generator 54 exceeds the output of the engine 31, the electric power stored in the capacitor 34 or the battery 35, in addition to the power output from the power generator 32, is supplied as the motor power source for the motors 25,45 and the motor generator 54.

Next, FIG. 8 is a circuit diagram showing an embodiment of a work machine driving device according to the present invention, wherein the elements corresponding to those in FIG. 2 or FIG. 7 are identified with the same reference characters, with the explanation thereof being omitted.

The driving device shown in FIG. 8 is a composite hybrid driving device of the hydraulic excavator and includes a second working example of a boom-stick-bucket-travel composite circuit, wherein a reduction gear unit 99 serving as a power transmission device is connected to an output axis of an engine 31. A motor generator 54 which functions as both a motor and a power generating device is connected to the reduction gear unit 99. The driving device also includes a power storage device 33 which serves to store the electric power generated by the motor generator 54 and also supply the motor generator 54 with the electric power stored in the power storage device 33.

A pump motor 52 and a plurality of pumps 46 are connected to the reduction gear unit 99. The pump motor 52 functions as both a pump, which is adapted to be driven by either one of or both the engine 31 and the motor generator 54, and a hydraulic motor, i.e. an oil hydraulic motor, for driving the motor generator 54. The pumps 46 are adapted to be driven by either one of or both the engine 31 and the motor generator 54.

A mechanism for switching the direction of rotation of only the pump motor 52 and a clutch mechanism are incorporated in the reduction gear unit 99. The clutch mechanism is adapted to connect the pump motor 52 directly to the motor generator 54 and simultaneously separate the pump motor 52 from the engine 31 and the pumps 46.

As is true in the embodiment shown in FIG. 7, hydraulic oil discharged from the pump motor 52 is fed to the driving circuit 41 for the boom cylinders 3a; hydraulic oil discharged from one of the pumps 46 is fed to the driving circuit 42 for the stick cylinder 4a and the right side-travel motor 91R; and hydraulic oil discharged from the other pump 46 is fed to the driving circuit 43 for the bucket cylinder 5a and the left side-travel motor 91L. The present embodiment differs from the embodiment shown in FIG. 7 in that the pumps 46 and the pump motor 52 are mounted, together with the engine 31 and the reduction gear unit 99, on the upper structure 2 of the hydraulic excavator.

Next, the functions and effects of the embodiment shown in FIG. 8 are explained hereunder. The explanation of the functions and effects resulting from a constitution similar to that of any one of the embodiments described above is omitted.

The engine 31 operates under a given, constant load. When the amount of power consumed by the various actuators, such as the boom cylinders 3a, the stick cylinder 4a, the bucket cylinder 5a, and the motor 25 for the turning system is small, the excess engine power causes the motor generator 54 to function as a power generating device so that the electric power output from the motor generator 54 is charged on the capacitor 34 or the battery 35.

When the power required by the actuators exceeds the output of the engine 31, the electric power stored in the capacitor 34 or the battery 35 is supplied as the motor power source for the motor generator 54 so that the motor generator 54 functions as a motor.

By means of the supporting circuits 61,63,65, supporting hydraulic oil can be fed from the driving circuit 41 for the boom cylinders 3a, which has a relatively low flow rate requirement, to the driving circuit 42 for the stick cylinder 4a in the excavation mode during excavation operation by a hydraulic excavator; supporting hydraulic oil can be fed from the driving circuit 43 for the bucket cylinder 5a, which has a relatively low flow rate requirement, to the driving circuit 41 for the boom cylinders 3a, which is in need of flow rate in the turn-and-raise mode; and hydraulic oil can be fed from the driving circuit 43 for the bucket cylinder 5a, which has a relatively low flow rate requirement, to the driving circuit 42 for the stick cylinder 4a, which is in need of flow rate in the turn-and-lower mode.

As described above, the supporting circuits 61,63,65 enable the plurality of driving circuits 41,42,43 to effectively share excess energy generated from hydraulic fluid so that the capacities of the components of the driving circuits 41,42,43, including the pump motor 52 and the pumps 46, can be individually reduced. Therefore, these components can be made compact, resulting in reduction of their production costs. Furthermore, the circuits shown in FIG. 8 enable either one of or both the engine 31 and the motor generator 54 to drive either one of or both the pump motor 52 and the pumps 46 by means of the reduction gear unit 99. Therefore, with the exception of the motor 25 for the turning system, the motors for driving the pumps can be eliminated. As the number of electric motors, which are more expensive than hydraulic devices, can be reduced, in this aspect, too, the circuits shown in FIG. 8 are effective in cost reduction, compared with the circuits shown in FIG. 2 or FIG. 7.

### POSSIBLE INDUSTRIAL APPLICATION

Application of the present invention is not limited to a hydraulic excavator; it is applicable to a wide range of work machines, including loaders, provided that the work machine has a working unit to be operated by a plurality of actuators.

1. A work machine driving device for operating a working unit by a plurality of hydraulic actuator systems, the work machine driving device comprising:
an engine;
a power generating device adapted to be driven by the engine;
a power storage device for storing the electric power generated by the power generating device;
a plurality of driving circuits, each of which is provided for each respective hydraulic actuator system and adapted to be operated by electric power supplied from at least one of the power generating device and the power storage device so as to generate hydraulic pressure, thereby driving each respective hydraulic actuator system; and
one or more supporting circuits, each of which serves to feed supporting hydraulic fluid from one driving circuit to another driving circuit to make up a shortfall in the hydraulic fluid.

2. A work machine driving device as claimed in claim 1, wherein each driving circuit comprises:
a motor adapted to be operated at a controllable rotation speed by electric power supplied from at least one of the power generating device and the power storage device;
a pump adapted to be driven by the motor;
a valve unit adapted to control the direction of hydraulic fluid discharged from the pump so as to feed the hydraulic fluid to the corresponding hydraulic actuator system; and
a tank provided so that the hydraulic fluid that has been supplied from the pump to the corresponding hydraulic actuator system is recovered therein and returned to the pump.

3. A work machine driving device as claimed in claim 1, wherein each driving circuit is integrated with each respective hydraulic actuator system.

4. A work machine driving device as claimed in claim 1, wherein at least one of the driving circuits comprises:
a closed circuit;
a bi-directional pump motor, included in the closed circuits and functions as both a pump for supplying hydraulic fluid and a hydraulic motor adapted to operate by receiving hydraulic fluid; and
a motor generator having functions of both an electric motor, which is adapted to be operated by electric power supplied from at least one of the power generating device and the power storage device so as to drive the pump motor, and a power generating device be driven by the pump motor to generate electric power.

5. A work machine driving device for operating a working unit by a plurality of hydraulic actuator systems, the work machine driving device comprising:
an engine;
a power transmission device connected to the engine;
a motor generator connected to the power transmission device and functions as a motor and a power generating device;
a power storage device storing the electric power generated by the motor generator and supplying the motor generator with electric power;
a pump motor connected to the power transmission device, the pump motor having functions of both a pump adapted to be driven by at least one of the engine and the motor generator, and a hydraulic motor driving the motor generator;
pumps connected to the power transmission device and driven by at least one of the engine and the motor generator;
a plurality of driving circuits respectively provided for the hydraulic actuator systems, each driving circuit adapted to be operated by hydraulic fluid supplied from at least one of the pump motor and the corresponding pump, thereby driving the corresponding hydraulic actuator system, and recover back to a tank and return to at least one of the pump motor and the corresponding pump the hydraulic fluid returned from the hydraulic actuator system; and
at least one supporting circuit which serves to feed supporting hydraulic fluid from one driving circuit to another driving circuit to make up shortfall in the hydraulic fluid.

6. A work machine driving device as claimed in claim 1, wherein at least one common driving circuit is connected to a plurality of parallelly arranged hydraulic actuators.

7. A work machine driving device as claimed in claim 1, wherein the power storage device comprises a capacitor and a battery.

8. A work machine driving device as claimed in claim 2, wherein each tank is pressurized by means of a pressure accumulator.

9. A work machine driving device as claimed in claim 1, wherein the hydraulic actuator systems comprise:
a boom cylinder system for operating a boom of a hydraulic shovel;
a stick cylinder system for operating a stick; and
a bucket cylinder system for operating a bucket;
wherein the driving circuits comprise:
a driving circuit for driving the boom cylinder system;
a driving circuit for driving the stick cylinder system; and
a driving circuit for driving the bucket cylinder system; and
wherein the supporting circuits are provided for a line from the boom cylinder driving circuit to the stick cylinder driving circuit, a line from the bucket cylinder driving circuit to the boom cylinder driving circuit, and a line from the bucket cylinder driving circuit to the stick cylinder driving circuit, respectively.

10. A work machine driving device as claimed in claim 5, wherein at least one common driving circuit is connected to a plurality of parallelly arranged hydraulic actuators.

11. A work machine driving device as claimed in claim 5, wherein the power storage device comprises a capacitor and a battery.

12. A work machine driving device as claimed in claim 5, wherein each tank is pressurized by means of a pressure accumulator.

13. A work machine driving device as claimed in claim 5, wherein the hydraulic actuator systems comprise:
a boom cylinder system for operating a boom of a hydraulic shovel;
a stick cylinder system for operating a stick; and
a bucket cylinder system for operating a bucket;
wherein the driving circuits comprise:
a driving circuit for driving the boom cylinder system;
a driving circuit for driving the stick cylinder system; and
a driving circuit for driving the bucket cylinder system; and
wherein the supporting circuits are provided for a line from the boom cylinder driving circuit to the stick cylinder driving circuit, a line from the bucket cylinder driving circuit to the boom cylinder driving circuit, and a line from the bucket cylinder driving circuit to the stick cylinder driving circuit, respectively.

14. A work machine driving device as claimed in claim 2, wherein the hydraulic actuator systems comprise:
a boom cylinder system for operating a boom of a hydraulic shovel;
a stick cylinder system for operating a stick; and
a bucket cylinder system for operating a bucket;
wherein the driving circuits comprise:
a driving circuit for driving the boom cylinder system;
a driving circuit for driving the stick cylinder system; and
a driving circuit for driving the bucket cylinder system; and
wherein the supporting circuits are provided for a line from the boom cylinder driving circuit to the stick cylinder driving circuit, a line from the bucket cylinder driving circuit to the boom cylinder driving circuit, and a line from the bucket cylinder driving circuit to the stick cylinder driving circuit, respectively.

15. A work machine driving device as claimed in claim 4, wherein the hydraulic actuator systems comprise:
a boom cylinder system for operating a boom of a hydraulic shovel;
a stick cylinder system for operating a stick; and
a bucket cylinder system for operating a bucket;
wherein the driving circuits comprise:
a driving circuit for driving the boom cylinder system;
a driving circuit for driving the stick cylinder system; and
a driving circuit for driving the bucket cylinder system; and
wherein the supporting circuits are provided for a line from the boom cylinder driving circuit to the stick cylinder driving circuit, a line from the bucket cylinder driving circuit to the boom cylinder driving circuit, and a line from the bucket cylinder driving circuit to the stick cylinder driving circuit, respectively.

16. A work machine driving device as claimed in claim 2, wherein at least one of the driving circuits comprises:
a closed circuit;
a bi-directional pump motor, included in the closed circuit, and functions as both a pump for supplying hydraulic fluid and a hydraulic motor adapted to operate by receiving hydraulic fluid; and
a motor generator having functions of both an electric motor, which is adapted to be operated by electric power supplied from at least one of the power generating device and the power storage device so as to drive the pump motor, and a power generating device be driven by the pump motor to generate electric power.
